(19) United States
(12) Patent Application Publication
(10) Pub. No.: US 2008/0201768 A1
(43) Pub. Date: Aug. 21, 2008

(54) Method For Managing A Large Number Of Passwords, Portable Apparatus And Certification Information Storing Device Using The Same, And Certification Information Management Method Using The Same

(76) Inventors: Hong-Sik Koo, Seoul (KR); Jong-Sik Koo, Seoul (KR); Il Joe, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 11/994,691

(22) PCT Filed: Jul. 10, 2006
(86) PCT No.: PCT/KR2006/002707

§ 371 Date: Jan. 4, 2008

(30) Foreign Application Priority Data
Jul. 8, 2005 (KR) 10-2005-0061886
Aug. 29, 2005 (KR) 10-2005-0079553

(51) Int. Cl. G06F 21/00

(52) U.S. Cl. 726/6; 726/10

(57) ABSTRACT

Disclosed herein are a password management apparatus and method, a certification information storage apparatus and a certification information management method. The password management method of accessing and managing desired passwords through a portable password management apparatus and a terminal on which a password management program is installed, includes a first step of executing the password management program on the management terminal, a second step of receiving a user authentication number from the management apparatus, and comparing the first authentication number with a user authentication number previously stored in the management terminal, thereby authenticating whether a user is a legitimate user, and a third step of, only if the user is authenticated as a legitimate user, receiving a password list from the management apparatus and outputting the received password list onto a screen.

### TECHNICAL FIELD

The present invention relates to a method of accessing a desired password through a portable password management apparatus (hereinafter referred to as a ‘management apparatus’) and a terminal (hereinafter referred to as a ‘management terminal’) on which a password management program is installed. Furthermore, the present invention relates to a certification information storage apparatus for storing passwords used for various Internet sites, files, folders and the like and transmitting the passwords to a management terminal when necessary, and a certification information management method of checking the sent passwords on the management terminal and automatically providing a specific password for a corresponding site, file, or the like.

### BACKGROUND ART

With the development of the communication environment, a great number of sites can be accessed over the Internet and desired services can be received. Some of the services provided online are available to anyone without particularly limiting users. However, in some sites such as electronic commerce sites or home banking sites, subscriptions to memberships are indispensable. At the time of membership subscription, the registration of member IDs and passwords is required so as to distinguish respective users.

In the latter case, whenever a user subscribes to each site, the same ID and password may be used. In this case, if only one ID and one password are found out by someone, that person can access all sites to which the user has subscribed using the ID and password, therefore a security problem arises. In contrast, in the case where a user registers different IDs and passwords with sites, security is enhanced, but the user may forget registered IDs or passwords if the user has not accessed the sites for a long time. Therefore, there is inconvenience in that the user must inquire about IDs or passwords from managers.

Furthermore, when the situation in which various authorized certification numbers for electronic transactions, passwords for bank transactions and passwords set for electronic documents as well as the IDs and passwords for sites are added is taken into account, there is a tendency for the number of passwords, which must be memorized by a user, to be beyond the bounds of memorization. However, there has not been disclosed a means for checking and managing various pieces of ID and/or password-related information regardless of place while integrally managing them.

### DISCLOSURE OF INVENTION

### Technical Problem

Accordingly, the present invention has been made keeping in mind the above problems occurring in the prior art, and an object of the present invention is to allow a user to check a desired password by sending a corresponding list to a management terminal, on which a password management program is installed, when necessary while storing password lists in an accessory-type portable password management apparatus.

Another object of the present invention is to modify the password lists or add entries to the password lists through the password management program installed on the management terminal.

A further object of the present invention is to enhance security by encrypting data exchanged between the portable password management apparatus and the management terminal.

Yet another object of the present invention is to generate various password combinations through a key input pattern while simplifying the input unit of the portable password management apparatus.

Still another object of the present invention is to allow the user to check a desired password by receiving a certification information DB using the management terminal when necessary while storing the certification information DB, including a plurality of passwords, in a storage apparatus at normal times.

Still another object of the present invention is to automatically enter specific certification information of the certification information DB, output to the management terminal, in the certification information input box of an Internet site being accessed or a file being selected.

Still another object of the present invention is to maximize the portability of the storage apparatus by performing user authentication in the certification information storage apparatus and the transmission of certification information to the management terminal through a minimum number of key buttons that can be manipulated in various ways.

Still another object of the present invention is to store and check passwords for media, which cannot be easily accessed through the management terminal, by providing memo fields in the certification information DB.

Still another object of the present invention is to recover an existing certification information DB in the case where a serial number is known even if the storage apparatus has been lost, by substituting a combination of a master key and a serial number into an algorithm for generating certification information for a seed value.

### Technical Solution

In order to accomplish the above objects, the present invention provides a password management method of accessing and managing desired passwords through a portable password management apparatus (hereinafter referred to as a ‘management apparatus’ and a terminal (hereinafter referred to as a ‘management terminal’) on which a password management program is installed, the password management method including a first step of executing the password management program on the management terminal; a second step of receiving a user authentication number (hereinafter referred to as a ‘first authentication number’) from the management apparatus, and comparing the first authentication number with a user authentication number (hereinafter referred to as a ‘second authentication number’) previously stored in the management terminal, thereby authenticating whether a user is a legitimate user;

and a third step of, only if the user is authenticated as a legitimate user, receiving a password list from the management apparatus and outputting the received password list onto a screen.

In this case, the password management method may further include the steps of, if the second authentication number is not previously stored in the management terminal, requesting self-authentication from the management apparatus, and performing the third step only when notification of successful self-authentication is provided by the management apparatus. The self-authentication in the management apparatus includes the steps of receiving a password through an input unit of the management apparatus;

comparing the received password and the user authentication number previously stored in the management apparatus; and notifying the management terminal of successful self-authentication if the received password is identical to the user authentication number, and notifying the management terminal of unsuccessful self-authentication if the received password is not identical to the user authentication number.

The password management method may further include the steps of modifying a specific field of a specific record of the password list output to the management terminal; and sending a modified password list to the management apparatus and backing up the password list. The password management method may further include the steps of adding a new record to the password list; and sending the password list, to which the new record is added, to the management apparatus and backing up the password list.

Each record of the password list includes a description field for a password, and a password field.

Meanwhile, the modification of the specific field or the addition of the new record is performed through the input means of the management terminal or the input unit of the management apparatus.

The password management method may further include a reference information setting step, including the steps of setting a communication interface type and a transmission speed that are used to perform communication between the management terminal and the management apparatus; requesting the user authentication number from the management apparatus based on the set communication interface type and transmission speed; and storing the set communication interface type and transmission speed and the user authentication number, received in response to the request, in the management terminal. The password management method may further include, before the step of requesting the user authentication number, the steps of requesting a serial number of a corresponding device from the management apparatus; and proceeding to a subsequent step only if the serial number received from the management apparatus is identical to a serial number previously stored in the management terminal.

The password management method may further include a certification information mediation step, including the steps of receiving a user authentication number (hereinafter referred to as a ‘third authentication number’) received through an input unit of the management apparatus, and providing the received third authentication number to a specific application requiring user authentication.

Meanwhile, the communication between the management terminal and the management apparatus is performed via encryption using a predetermined algorithm, and the communication between the management terminal and the management apparatus is performed wirelessly through a relay apparatus connected to the management terminal via a wired communication interface, or in a wired manner through direct connection between a communication interface of the management terminal and a communication interface of the management apparatus.

The user authentication number is generated by selecting two or more keys provided in an input unit of the management apparatus according to a specific pattern.

Additionally, the present invention provides a certification information management method of accessing, managing and applying various types of certification information using a certification information storage apparatus and a management terminal, including a user authentication step of determining whether a user is a legitimate user in a certification information storage apparatus by comparing a password, received from a user, and a previously stored password (master key); a certification information sending step of sending a certification information DB, previously stored in the certification information storage apparatus, to the management terminal via a communication interface; and a certification information output step of outputting the received certification information DB onto a screen through a certification information management program of the management terminal.

The certification information DB comprises a first table, including login ID fields, password fields for corresponding IDs, and address fields for Internet sites to which corresponding login IDs and passwords will be applied. The certification information management method may further include a certification information application step, including the steps of the management terminal accessing a specific Internet site through a browser; the certification information management program searching the first table for an address identical to that of the accessed Internet site; and automatically entering a login ID field value and a password field value for the identical address in login ID and password input boxes of the corresponding site.

The certification information DB may further include a second table, including file name fields, and password fields for corresponding files. The certification information management method may further include a certification information application step, including the steps of the management terminal requesting a password from a user as a specific file is selected or executed; the certification information management program searching the second table for a file name identical to that of the selected specific file; and automatically entering a password field value for the identical file name in a password input box of the specific file.

The certification information DB may further include a third table, including a system password field for the management terminal. The certification information management method may further include the steps of requesting a system password from a user as the management terminal is booted; the certification information management program automatically substitute a system password field value of the certification information DB for the system password.

The certification information DB may further include a fourth table, including memo fields having a predetermined size.

Meanwhile, the certification information management method may further include a certification information editing step, including the steps of editing one or more of a login ID field, an Internet site address field, a file name field and a memo field of the certification information DB through the certification information management program; and sending a certification information DB, modified through the editing, to the certification information storage apparatus and updating a certification information DB of a corresponding certification information storage apparatus.

The certification information management method may further include a certification information storage apparatus initialization step, including a master key registration step of the certification information storage apparatus receiving a password having a predetermined number of digits for user authentication, and storing the received password as a master key; a seed key input step of substituting the password into an algorithm for generating certification information using the master key as a seed key; and a certification information DB construction step of constructing a database using a predetermined number of pieces of certification information generated by the algorithm. The seed key is a combination of the master key and a serial number of a corresponding certification information storage apparatus. In this case, the seed key input step is performed using a serial number received through the certification information management program of the management terminal, instead of a serial number that is previously stored in the certification information storage apparatus.

### Advantageous Effects

According to the present invention, there are the advantages of easily checking a desired password anywhere using an accessory-type portable password management apparatus in which a password list is stored, and checking a desired password by sending a corresponding list from the password management apparatus or to a specific management terminal over the Internet using a predetermined password management program.

Another advantage of the present invention is to modify the password lists or add entries to the password lists through the password management program installed on the management terminal.

A further advantage of the present invention is to enhance security by encrypting data exchanged between the portable password management apparatus and the management terminal.

Yet another advantage of the present invention is to generate various password combinations through a key input pattern while simplifying the input unit of the portable password management apparatus.

Furthermore, according to the present invention, a user sends a desired password to the management terminal when necessary while storing a plurality of passwords, which are being used in the daily life, in a certification information storage apparatus, so that the user can check the desired password. Accordingly, it is unnecessary to memorize all of the passwords, therefore the efficiency of password management can be increased. Moreover, security can be further enhanced through the integral management of the passwords.

Furthermore, in the case where the certification information management program is being executed in the management terminal, the specific certification information of the certification information DB can be automatically entered in the certification information input box of an Internet site being accessed, a file being selected, or the like. Accordingly, there is no possibility that error may occur at the time of inputting a password, and the user does not need to memorize passwords in text form. Furthermore, memo fields are provided in the certification information DB, therefore it is possible to store and check general information, such as book lending related-information, school affair management information and personal information, and log information, such as a computer use history, a site access history and an entry authentication history for a specific door locking device, as well as certification information for media that cannot be easily and directly accessed through the management terminal, such as bank account numbers and passwords, and credit card numbers and passwords.

Moreover, user authentication in the certification information storage apparatus and the transmission of certification information to the management terminal can be performed through a minimum number of key buttons that can be manipulated in various ways, thus facilitating the carrying of the storage apparatus. Moreover, a combination of a master key and a serial number is substituted into an algorithm for generating certification information for a seed value, therefore an existing certification information DB can be recovered in the case where a serial number is known even if the certification information storage apparatus has been lost.

### BRIEF DESCRIPTION OF THE DRAWINGS

FIG. 1 is a diagram showing the schematic configuration of a password management system according to the present invention;

FIG. 2 is a block diagram of an internal construction of a password management apparatus according to the present invention;

FIG. 3 is a block diagram illustrating the internal construction of a relay apparatus of the password management system according to the present invention;

FIG. 4 is a flowchart sequentially illustrating respective steps of a password management method according to the present invention;

FIG. 5 is a screen illustrating an embodiment of the reference information setting step of the password management method according to the present invention;

FIG. 6 is a screen illustrating an embodiment of the user authentication step of the password management method according to the present invention;

FIG. 7 is a screen illustrating an embodiment of the password list output step of the password management method according to the present invention;

FIG. 8 is a diagram illustrating the construction of a system for implementing the certification information management method according to the present invention;

FIG. 9 is a block diagram illustrating the internal construction of a certification information storage apparatus according to the present invention;

FIGS. 10 to 12 are diagrams illustrating the structures of respective tables of a certification information DB according to the present invention;

FIGS. 13 to 17 are flowcharts sequentially illustrating a certification information management method according to the present invention;

FIG. 18 is an embodiment of the certification information output step of the certification information management method according to the present invention; and

FIG. 19 is an embodiment of the certification information entering step of the certification information management method according to the present invention.

### BEST MODE FOR CARRYING OUT THE INVENTION

Preferred embodiments will be described in detail with reference to the accompanying drawings attached to the specification of the present invention below. It should be noted that, in the assignment of reference numerals to the elements of respective drawings, the same reference numerals are assigned to the same elements as far as possible, even though the elements are illustrated in different drawings. Furthermore, in the description of the present invention, detailed descriptions of related well-known functions or constructions will be omitted if it is determined that such descriptions would make the gist of the present invention unnecessarily vague.

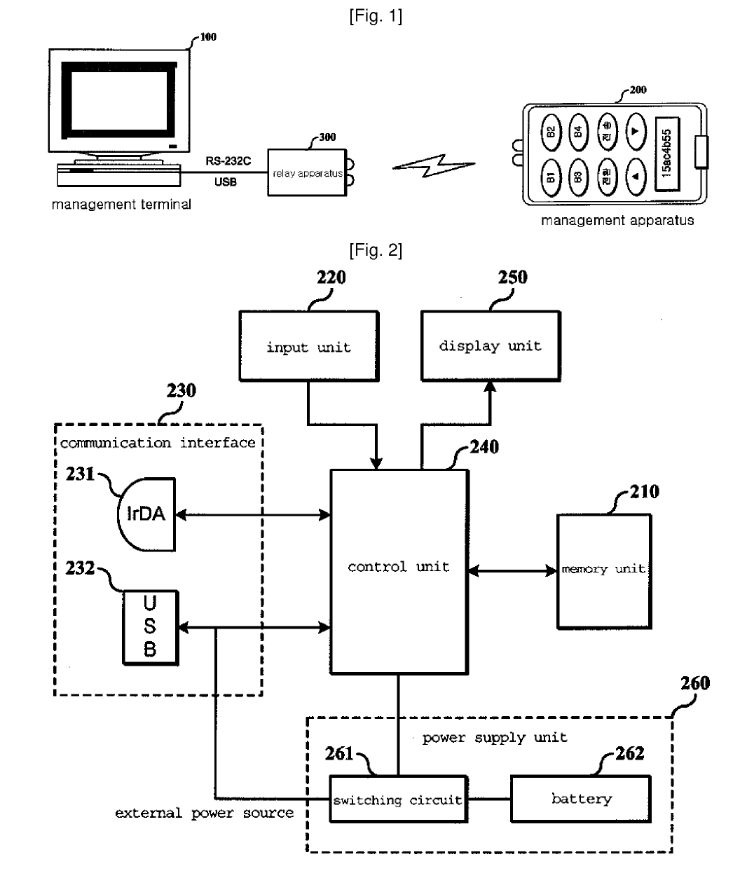

FIG. 1 shows the schematic configuration of a password management system according to the present invention.

A password management program for receiving a password list from a management apparatus 200, displaying the received password list on a screen, and adding a new password to the password list or modifying a specific password is installed on a management terminal 100. The password management program may be downloaded and installed from a server (not shown) through the Internet when necessary, or a program stored in the management apparatus 200 may be downloaded and installed. In the latter case, it is preferred that an application be further mounted in the management apparatus 200, the application including an algorithm for determining whether a password management program has been installed on the management terminal 100 connected via communication, and, if the password management program is determined not to have been installed on the management terminal 100, asking a user whether to install the password management program, downloading the corresponding program and automatically installing the downloaded program.

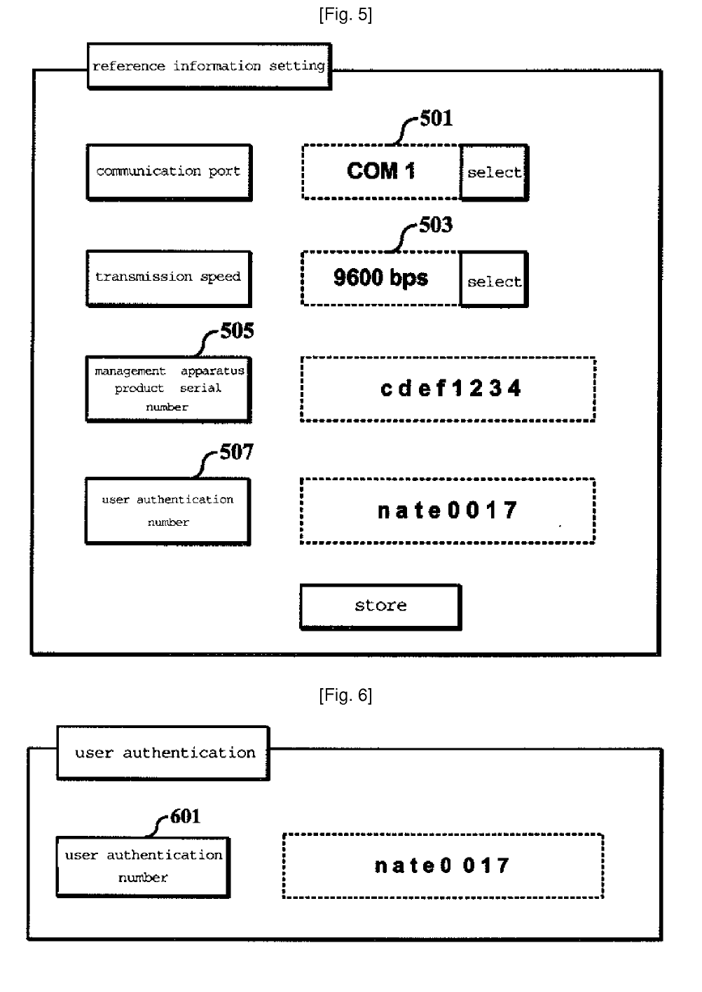

An electronic terminal, such as a PC, a PDA, a notebook, a cellular phone or a PCS phone, including a memory unit for storing the password management program, a control unit for executing the program, a communication interface for performing data communication with the management apparatus 200, and a display unit for displaying the process of executing the program, may be used as the management terminal 100. Particularly, in the present embodiment, a description will be given using a PC as an example. Meanwhile, an embodiment of the detailed interface and operation of the password management program will be described with reference to FIG. 4 later.

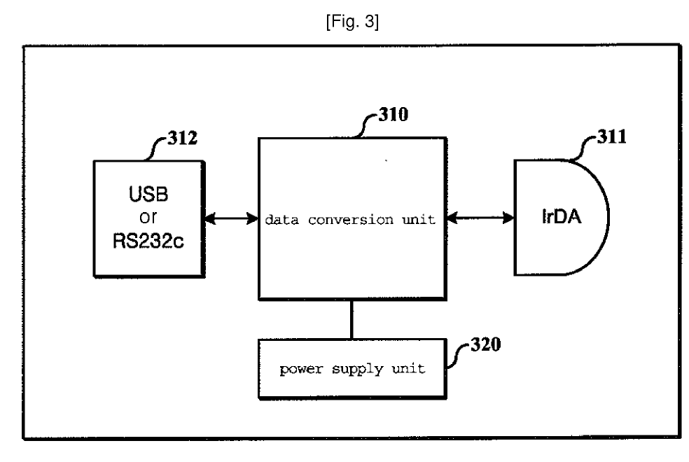

The management apparatus 200 sends the password list to the specific management terminal 100 on which the password management program is installed, so that a desired password can be selected. The management apparatus 200 is preferably implemented in the form of a portable accessory. Alternatively, it is possible to combine the management apparatus 200 with a mobile communication terminal, such as a PDA, a cellular phone, a PCS phone or a notebook, and to allow the management apparatus to constitute part of the functionality of the mobile communication terminal. FIG. 2 illustrates the internal construction of the password management apparatus 200 using blocks. The detailed roles of the respective elements thereof will be described with reference to FIG. 2 below.

A memory unit 210 stores a password list, which is a set of passwords to be managed by a user, and a user authentication number for authenticating whether the user has a legitimate right to access the password list. Preferably, the memory unit 210 may further store an install program for accessing the management terminal 100, determining whether the password management program has been installed, and, if the password management program has not been installed, downloading the corresponding program and automatically installing the corresponding program on the management terminal 100. Since the user authentication number, the password list and the install program must be maintained and updated regardless of whether power is supplied, the memory unit 210 of the present invention must include EEPROM or flash memory. Meanwhile, in the case where user authentication is performed using fingerprint data, the fingerprint data, instead of the user authentication number, may be stored.

An input unit 220 generates number/character codes or various control codes based on the user's selection. In the present invention, the input unit 220 includes four or five character/number input buttons for inputting a user authentication number or a password field value of a password list, a “Send” button for ordering various input password data to be sent to the management terminal 100, a “Switch” button for selecting character input or number input, and up and down buttons for moving each record of the password list so that a desired ID or password is displayed on a display unit 250.

The configuration of the key buttons is only an embodiment, and a key button may be further included, or some of the buttons may not be included within a range that does not deviate from the purpose of the present invention, in which portability is emphasized.

Particularly, in the present embodiment, the case where four character/number input buttons B1, B2, B3 and B4 are included is taken as an example. The user can generate a user authentication number, an ID and a password by pressing the buttons according to a specific pattern. For example, if “B1-B1-B2-B4-B2-B2-B4-B2-B1-B3-B3-B3” are pressed, specific codes corresponding to B1-B1, B2, B4, B2-B2, B4, B2, B1, and B3-B3-B3 may be combined and produce an 8-byte password. Furthermore, in the case where there exist specific codes corresponding to B1, B2, B3 and B4, respectively and “B1-B1-B2-B3-B1-B4-B3-B3” is pressed, an 8-byte password combined in that order may be generated. Meanwhile, in the case where a combination of characters and numbers is compulsory for a password, a password is generated by toggling an input mode through the repeated pressing of a “Switch” button and then pressing characters or numbers.

When a “Send” button is pressed after the password, generated as described above, is temporarily stored in the memory unit 210, the transmission of the password to the management terminal 100 starts. In the case where only the number buttons B1, B2, B3, B4 and B5 are included, unlike the above embodiment, the code of a corresponding key may be sent to the management terminal 100 whenever a specific button is pressed, and the password management program of the management terminal 100 may receive key codes that are sent in the manner described above and correspond to a preset digit, and may combine them into one password.

However, user authentication is not necessarily performed using the password. User authentication may be performed using a user's biometric information, and, for this purpose, a fingerprint recognition sensor may be further included in the input unit 220.

A communication interface 230 serves as a path for exchanging various data with the management terminal 100. A wireless communication interface, such as Infrared Digital Association (IrDA) or Bluetooth, or a wired communication interface, such as Universal Serial Bus (USB) or RS-232C, may be used as the communication interface 230. In the present embodiment, the case where both the wired/wireless communication interfaces are provided is given as an example, and an IrDA 231 port and a USB 232 port are employed respectively for the wireless communication and the wired communication, respectively. Since various communication interface schemes are well known in the art, descriptions thereof are omitted here.

If there is a request for a user authentication number from the management terminal 100, a control unit 240 receives a password through the input unit 220 and sends the received password to the management terminal. If there is a request for authentication from the management terminal 100 itself, the control unit 240 receives a password through the input unit, compares the received password with a previously stored user authentication number, and notifies the management terminal 100 of successful authentication or unsuccessful authentication. The control unit 240 sends a previously stored password list to the management terminal 100 in response to the request for the password list by the management terminal.

Furthermore, a function of, in the case where an Internet site requiring user authentication is accessed or user authentication is required by a specific application, requesting a password for user authentication (hereinafter referred to as a “third authentication number”) from the management apparatus 200, receiving a specific record of a password list corresponding to the request from the management apparatus 200, or receiving information input by the user, and automatically inputting the input information to the user authentication information input box of a corresponding site or application may be further included. In this case, if there is a request from the control unit 240, the management apparatus 200 receives the third authentication number from the user and temporarily stores the received third authentication number. When the management apparatus 200 accesses the wired communication interface 232 of the management terminal 100, the management apparatus 200 may allow the third authentication number to be automatically input to the user authentication information input box of a corresponding site or application.

As a result, a password can be directly decrypted using the management apparatus 200 according to the present invention. Such a decryption function may be applied to the decryption of a system password at the time of PC booting, the decryption of a password set in a specific document file, the decryption of the password of an authorized certificate for financial transactions, and so on in various manners.

The display unit 250 outputs the ID field value or password field value of a specific record of the password list, therefore desired information can be rapidly checked without using the management terminal 100. The display unit 250 also displays the key code value received through the input unit 220, thereby allowing the user to check whether a specific button has been appropriately pressed, and outputs various guide messages in the process of data communication with the management terminal 100, thereby allowing the user to check whether a corresponding process has been completed and whether a subsequent process is ready to be started. In order to select the type of information displayed on the display unit 250, additional selection buttons may be added to the input unit 220. However, it is further preferred that the type of information be selected by pressing the existing keys for a time longer than a predetermined time.

A power supply unit 260 is responsible for supplying power to respective elements constituting the management apparatus. A battery 262, including a primary battery or a secondary battery, or an external power source may be used as the power supply unit 260. In the present embodiment, the case where both the battery 262 and the external power source are used at the same time is taken as an example. In particular, the power of an external electronic device, which is applied through the USB port 232, is used for the external power source. A switching circuit 261 is provided between the battery 262 and the external power source so that the external power source and the power of the battery 262 are supplied exclusively. When the secondary battery is used as the battery 262, it is preferable that a charging circuit be further provided.

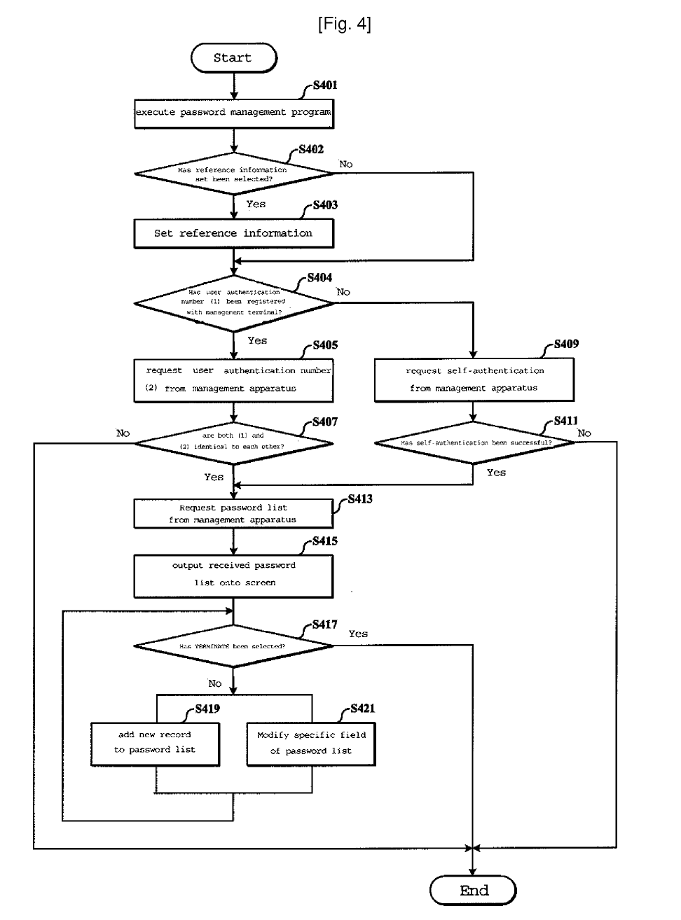

In the present invention, when a PDA, a notebook, or the like, including the wireless communication interface therein, is used as the management terminal 100, there is no problem because direct data communication with the management apparatus 200 is possible. In contrast, in general, when a PC or the like, including only the wired communication interface, is used as the management terminal 100, a relay apparatus 300 for converting communication protocols between the management terminal 100 and the management apparatus 200 must be further included as a measure for utilizing the wireless communication interface of the management apparatus 200. FIG. 3 is a block diagram of the internal construction of the relay apparatus 300. With reference to FIG. 3, the detailed roles of the respective elements will be described below.

The relay apparatus 300 includes both a wired communication interface (USB port or RS-232C port) 312 and a wireless communication interface (IrDA port) 311, and forwards data, which is received through one interface, to the other interface.

A data conversion unit 310 is responsible for converting data, which is received via a communication protocol supported by one interface, into data suitable for a communication protocol supported by the other interface. A power supply unit 320 supplies power to the data conversion unit 310, and may be implemented in the same manner as the power supply unit 260 of the management apparatus 200.

Meanwhile, since the communication between the management terminal 100 and the management apparatus 200 can be performed through encryption using an algorithm, the risk of a password being intercepted during transmission and being exposed to other persons can be prevented. To this end, the management terminal 100 converts a request control signal or a modified password list by applying the request control signal or modified password list to an encryption algorithm at the time of transmission of the request control signal or the modified password list to the management apparatus 200, and also generates and sends an encryption code (public key) along with the request control signal or modified password list. The management apparatus 200 decrypts the received data using previously stored encryption code.

The procedure of accessing and managing a password list through the management terminal 100, the management apparatus 200 and the relay apparatus 300 will now be described in detail. For reference, FIG. 4 is a flowchart sequentially illustrating respective steps of a password management method according to the present invention.

A user who wants to know an ID and a password for an Internet site “A” desires to access information using an adjacent PC (management terminal 100). For this purposed, a password management program must be installed on the corresponding PC. The password management program may be downloaded and installed from a server over the Internet or may be downloaded and installed from the management apparatus according to the present invention.

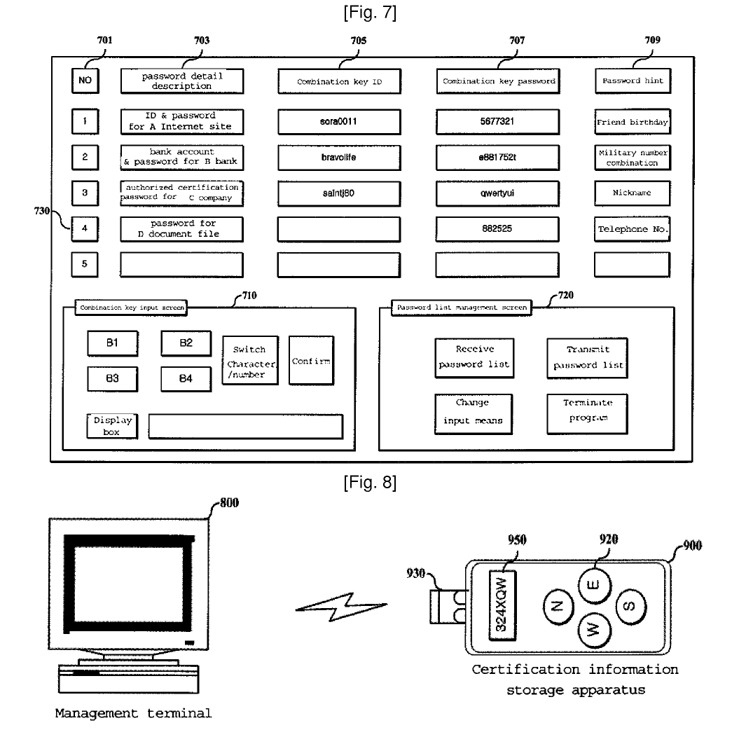

If execution is first performed after the installation of the program S402 when the password management program is executed at S401, information necessary for communication with the management apparatus of the user and various types of information necessary for user authentication (reference information) must be set in the program at step S403. An embodiment of the screen for setting the reference information is illustrated in FIG. 5.

A communication port setting box 501 allows COM1, COM2, USB, IRDA, Bluetooth, or the like to be selected in the management apparatus 200 of the user depending on whether the wired communication interface or the wireless communication interface is to be used. A transmission speed setting box 503 allows the data transmission speed for the management apparatus 200 to be set to 9600 bps, 15600 bps or the like. Thereafter, when a management apparatus product serial number button 505 is selected, a control signal requesting a product serial number is sent to the management apparatus 200 based on the set communication port and transmission speed, and information corresponding to the request is received within a predetermined time and is output to the product serial number setting box of the management apparatus. In this case, the management apparatus sends the product serial number of a corresponding device, previously stored in the memory unit 210, to the management terminal 100, via the set communication port and at the set transmission speed, in response to the request. Thereafter, when a user authentication number button 507 is selected, respective pieces of reference information are set through the same process as the serial number. The respective pieces of reference information set through the processes are stored in the reference information table of the management terminal 100 by activating a “Store” button placed at the lower end portion of the screen.

The reference information setting step S403 must be performed after a corresponding program is first executed and the reference information table of the management terminal 100 is initialized, and may be executed to change a specific reference information item.

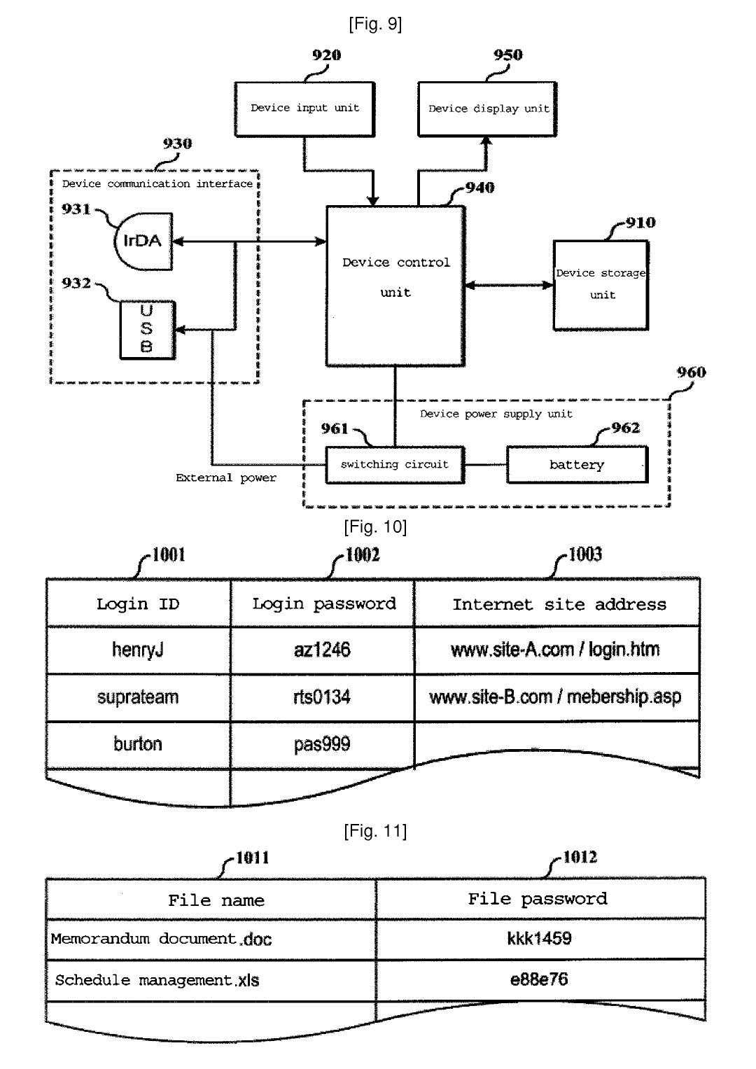

Thereafter, before the user receives the password list from the management apparatus 200, a user authentication procedure that examines whether the user has a legitimate right to receive the password list and to access the password list is then performed. An embodiment of the screen for requesting such user authentication is illustrated in FIG. 6. In FIG. 6, an authentication procedure is initiated by selecting the user authentication number button 601.

If a user authentication number (hereinafter referred to as a “first authentication number”) has been registered in the reference information table of the management terminal 100 at step S404, a control signal requesting a user authentication number (hereinafter referred to as a “second authentication number”) is sent to the management apparatus 200 and the second authentication number is received in response thereto at step S405. The management apparatus 200, which has received the request for the first authentication number from the management terminal 100, receives a password based on a predetermined pattern through the input unit 220, and sends the received password to the management terminal 100.

If the first authentication number has not been registered in the reference information table of the management terminal 100 for some reason, a control signal requesting self-authentication is sent to the management apparatus 200 and a self-authentication result value is received in response thereto at step S409. In this case, the management apparatus 200, which has received the request for self-authentication from the management terminal 100, receives a password through the input unit 220, and compares the received password with a user authentication number previously stored in the memory unit 210. The management apparatus 200 sends a result value providing notification of successful self-authentication to the management terminal 100 if the received password is identical to the user authentication number, and sends a result value providing notification of unsuccessful self-authentication to the management terminal 100 if the received password is different from the user authentication number, at step S411.

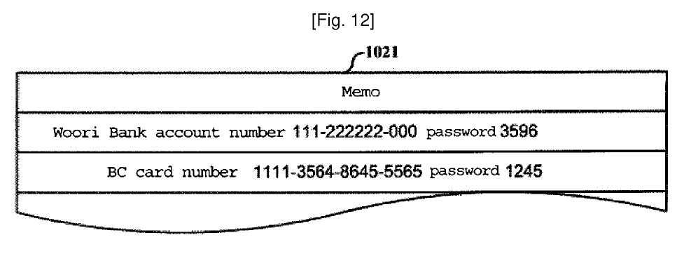

If the first authentication number is identical to the second authentication number at step S407 or the result value providing notification of successful self-authentication is received at step S411, this means that a corresponding user has a legitimate right, therefore, a control signal requesting the password list is immediately sent to the management apparatus 200 at step S413 and the received password list is displayed on the screen at step S415. FIG. 7 shows an embodiment of the password list output screen.

The password list in the present invention is a database that contains IDs, passwords and related information to be managed. The field values of respective records are sequentially listed on the output screen for the password list. The fields may include a record number field 701, a password content description field 703, a combination key ID field 705, a combination key password field 707, and a password hint field 709.

The user may not only check a specific ID and password through the password list output screen, but may also modify a specific item on the password list at step S421 or add a new record at step S410 through the combination key information input screen 710 and the password list management screen 720 provided on the lower side of the password list output screen.

That is, to newly add a record of the “password of document file D” 730, a user sequentially selects the password content description field 703, the combination key ID field 705, the combination key password field 707 and the password hint field 709, and makes entries in the selected fields through the input means (a keyboard, a touch screen, or the like) of the management terminal 100. Furthermore, key pattern input can be performed through a virtual management apparatus input unit 220 using the combination key information input screen 710. In this case, after a specific field is selected for input, the “B1”, “B2”, “B3” and “B4” buttons are selected according to a specific pattern. In this case, the input mode may be switched using the “Character/number switch” button. As a number or character is selected as described above, the selected key values are displayed on the display box on the lower end portion of the password list output screen. When the input is completed, the values are finally entered in the corresponding fields by selecting a “Confirm” button. Such a record addition procedure is applied to the modification of the values of the combination key ID field 705 and combination key password field 707 for a specific record in the same manner.

Meanwhile, the input unit of the management apparatus 220 may be directly used as a means for making entries in selected fields. In this case, the input means can be changed by selecting the “Input means change” button of the password list management screen 720. When the “Input means change” button is selected again, the input means is toggled to the input means of the management terminal.

The password list, in which a specific record has been added or modified through the above-described procedure, may be sent to the management apparatus 200 by selecting a “Password send” button, and may be used to back up the password list in the management apparatus 200. In the case where the password list has not been received from the management apparatus 200 for some reason, reception may be performed again by activating a “Password receive” button.

If user authentication has been unsuccessful or an “End” button has been selected at step S407 or S411, the password management program is terminated.

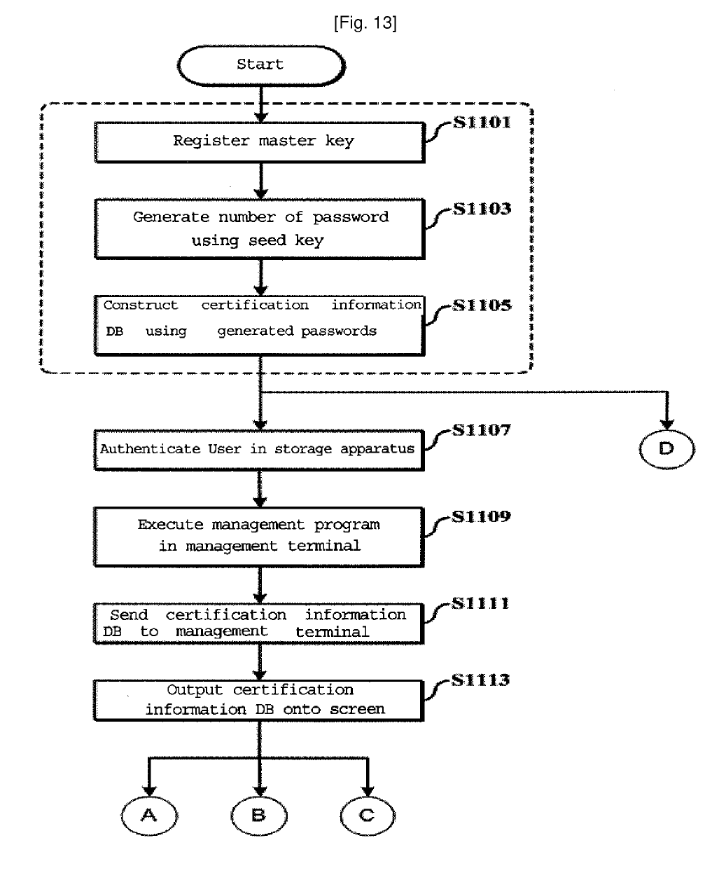

Meanwhile, for embodiments of the present invention, a certification information storage apparatus for storing passwords used for various Internet sites, files, folders, etc. and transmitting the passwords to the management terminal when necessary, and a certification information management method of checking received passwords in the management terminal and automatically providing a specific one of the passwords to a corresponding site, file, or the like are proposed. The certification information management method using the certification information storage apparatus will be described with reference to FIGS. 8 to 19.

FIG. 8 shows the configuration of a system for implementing the certification information management method according to the present invention.

In a management terminal 800 is installed a certification information management program for receiving a certification information DB from a certification information storage apparatus 900, outputting the received certification information DB onto the screen, editing a specific field of the certification information DB, and automatically entering a specific password, stored in the certification information DB, in a corresponding password input box so that a user can log in to an Internet site that is being accessed, or so that a selected file can be normally accessed. The certification information management program may be downloaded and installed from a server (not shown) over the Internet when necessary, or may be downloaded and installed from the certification information storage apparatus 900. In the latter case, it is preferred that, as data communication between the certification information storage apparatus 900 and the management terminal 800 is initiated, an automatic execution program, which is included in the certification information storage apparatus, run, determine whether the certification information management program has been installed on the management terminal 800, and, if the certification information management program has not been installed, ask the user whether to install the certification information management program, download a corresponding program and automatically install the downloaded program.

The management terminal 800 must include a storage unit for storing the certification information management program and the certification information DB, a central processing unit for executing the program, a communication interface for performing wired and/or wireless data communication with the certification information storage apparatus 900, and a display unit for outputting a process of executing the program. Representatively, a PC, a PDA, a notebook, a cellular phone, a telematics terminal, a PMP and the like may correspond to the management terminal 800.

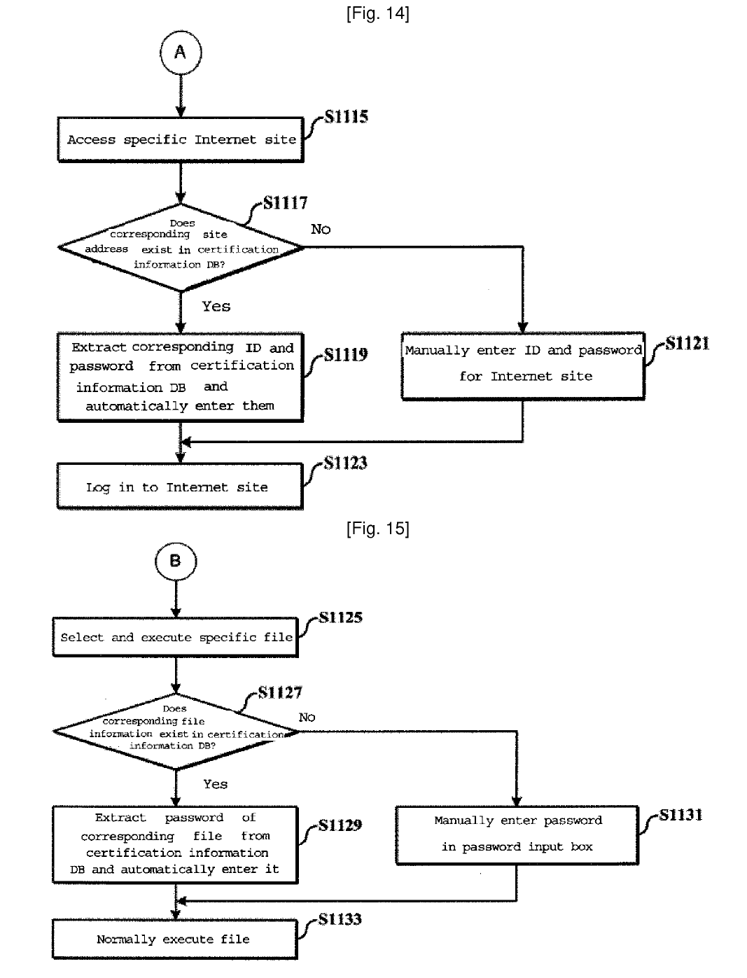

The certification information storage apparatus 900 sends the certification information DB to a specific management terminal 800 on which the certification information management program is installed, so a desired password can be checked. It is preferred that the certification information storage apparatus 900 be implemented in the form of a portable accessory. Furthermore, the certification information storage apparatus 900 may be combined with a mobile communication terminal, such as a PDA, a cellular phone or a PCS phone, and may be implemented as part of the functionality of the mobile communication terminal, or may be implemented as part of the functionality of an MP3 player, PMP or RFID card. FIG. 9 illustrates the internal construction of the certification information storage apparatus 900 using blocks. With reference to FIG. 9, the detailed roles of the respective elements thereof will be described below.

A device storage unit 910 stores a password (referred to as a “master key”) for authenticating whether a user has a legitimate right to access the certification information DB, a certification information DB, that is, a collection of passwords to be managed by a user, and serial numbers to be substituted into an algorithm for generating passwords constituting the certification information DB. Preferably, as described above, an automatic execution program for determining whether the password management program has been installed on the management terminal 800 when the certification information storage apparatus 900 is connected to the management terminal 800, and, if the password management program has not been installed on the management terminal 800, downloading the corresponding program to the management terminal 800 and automatically installing the corresponding program on the management terminal 800 may be further installed. Since the master key, the certification information DB, the serial number and the automatic execution program must be maintained regardless of whether power is supplied, the device storage unit 910 of the present invention must include, in particular, EEPROM, flash memory or NAND flash memory. Meanwhile, in the case where user authentication is performed using fingerprint data, the fingerprint data, instead of the master key, may be stored. In this case, the certification information storage apparatus 900 must further include a fingerprint scan unit (not shown).

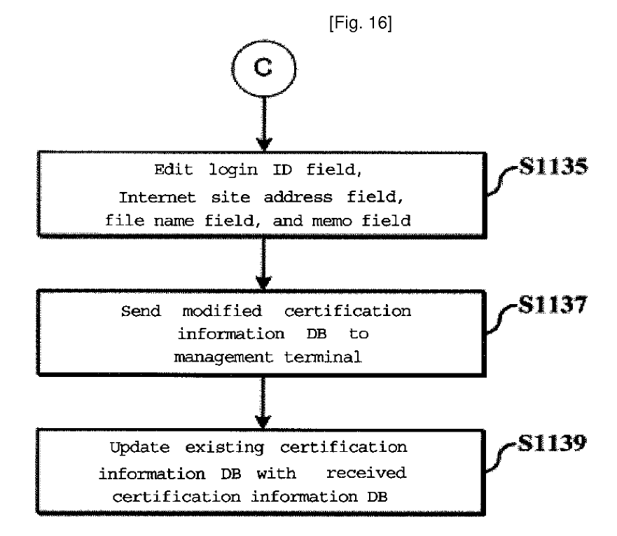

The construction of the certification information DB will be described below with reference to FIGS. 10 to 12.

That is, the certification information DB includes a first table (FIG. 10), which includes a login ID field 1001, a password field 1002 for a corresponding ID, and an address field 1003 for an Internet site to which a corresponding login ID and password will be applied. The certification information DB may further include one or more of a second table (FIG. 11) including a file name field 1011 and a password field 1012 for a corresponding file, a third table (not shown) including a system password field for a management terminal, and a fourth table (FIG. 12) including a memo field 1021 having a predetermined size. In this case, the data type of each field is preferably set to text. Since the third table and the fourth table are identical in format except that the names of corresponding fields are different, an illustration thereof is omitted here.

A device input unit 920 includes two or more key buttons to receive master key input for user authentication and a command to send the certification information DB to the management terminal. As the user selects the key buttons, number/character codes or various control codes are generated.

In the present embodiment, it is assumed that four key buttons are provided. Each of the key buttons performs a specific function assigned thereto when it is pressed for a time longer than a predetermined time, and inputs a character assigned thereto when it is pressed for a time shorter than the predetermined time. In more detail, if each button is pressed for a time shorter than a predetermined time, a preset number is input according to the number of presses. If the button is pressed for a time longer than the predetermined time, it performs functions of: 1) conversion of a currently input value into a character/number, 2) temporary storage of a currently input value and waiting for the input of a new value, 3) cancellation of a currently input value, and 4) sending of the certification information DB to the management terminal.

This will be described below in conjunction with detailed embodiments.

The four key buttons are named East (E), West (W), South (S) and North (N) buttons, respectively. A specific range of decimal numbers or duodecimal numbers is assigned to each of the East/West/South/North buttons. With decimal numbers taken as an example, the East (E) button is assigned 1 to 3, the West (W) button is assigned 4 to 6, the South (S) button is assigned 7 to 9, and the North (N) button is assigned 0. When a specific key button is pressed briefly a specific predetermined number of times, a corresponding number is input. Meanwhile, when a specific key button is pressed for a long time, a specific function assigned to a corresponding key button is performed. For example, the East (E; English) button is responsible for converting a currently input number into a corresponding English letter or an English letter into a corresponding number (it is assumed that the English alphabet small letters a to z respectively correspond to 1 to 26 and that the English alphabet capital letters A to Z respectively correspond to 27 to 52). The West (W, Waiting) button is responsible for temporarily storing a currently input letter in memory and allowing a subsequent input letter to be connected to the temporarily stored letter. The South (S, Sending) button is responsible for transferring a character string (password), input up to that moment, to the control unit or sending the certification information DB to the management terminal 800. The North (N, No or Cancel) button is responsible for canceling a currently input value or a temporarily stored value. In this case, if a predetermined time (for example, 2 seconds) elapses after one letter is input, a currently input letter is fixed and a subsequent letter is received. Therefore, the user can implement “1q” by inputting “East1-West (long)-East1-pause-South1-East (long)-West (long)”. Thereafter, the user may transmit the signal of the master key for user authentication to the control unit by pressing the South button (for a long time), or may transmit the certification information DB to the management terminal 800 if user authentication has already been completed.

The configuration of the key buttons is only an embodiment, and other key buttons may be further included, or some of the buttons may not be included, within a range that does not deviate from the purpose of the present invention, in which portability is emphasized.

A device communication interface 930 serves as a passage for exchanging various data with the management terminal 800. A wireless communication interface, such as IrDA or Bluetooth, or a wired communication interface, such as USB or RS-932C, may be used as the communication interface 930. In the present embodiment, the case in which both the wired/wireless communication interfaces are provided is taken as an example. The IrDA 931 port is employed as the wireless communication and the USB 932 port is employed as the wired communication. However, since the above-described communication interface schemes are well known in the art, detailed descriptions thereof are omitted here.

A device control unit 940 determines whether the user is a legitimate user by comparing a password, received from the user through the device input unit 920, and the master key, previously stored in the device storage unit 910, and sends the certification information DB to the management terminal 800 through the device communication interface 930 according to the user's selection if the user is determined to be a legitimate user.

Furthermore, the device control unit 940 may further have a function of updating the certification information DB of the device storage unit 910 using the certification information DB when the certification information DB in which one or more of the login ID field 1001, the Internet site address field 1003, the file name field 1011 and the memo field 1021 are modified is received from the management terminal 800.

Meanwhile, the device control unit 940 may further have a function of initializing the certification information storage apparatus, which receives a password having a certain number of digits for user authentication through the device input unit 920, stores the received password in the device storage unit 910 as a master key, substitutes the password into an algorithm for the generation of certification information using the master key as a seed key, and constructs the certification information DB using a pre-determined number of pieces of certification information generated by the algorithm. In this case, a value in which the master key and the serial number of the certification information storage apparatus are combined with each other may be used as the seed. In the case where the user has lost the certification information storage apparatus 900, a previous certification information DB can be reconstructed by registering the master key through the device input unit 920 of a new certification information storage apparatus, receiving the lost serial number of the certification information storage apparatus 900 through the certification information management program of the management terminal, combining the master key and the serial number, and inputting the combination result into a predetermined algorithm.

A device display unit 950 displays a key code value (an English letter or number), which is received through the device input unit 920, so that whether a specific appropriate button has been pressed can be examined. Furthermore, the device display unit 950 outputs various guide messages in the process of data communication with the management terminal 800, so that a user can examine whether a corresponding process is completed and a subsequent process is ready to be started.

A power supply unit 960 serves to supply power to the respective elements constituting the management apparatus. A battery 962 including the primary battery or the secondary battery may be used, or an external power source may be used. In the present embodiment, the case where both the battery 962 and the external power source are used at the same time is taken as an example. In particular, the power of an external electronic device, which is applied through the USB port 932, is used for the external power source. A switching circuit 961 is included between the battery 962 and the external power source, so that the external power source and the power of the battery 962 are supplied exclusively. When a secondary battery is used as the battery 962, it is preferred that a charging circuit be further included. Of course, the device power supply unit 960 does not necessarily need to be included. In the case where a conventional USB memory stick is used as the certification information storage apparatus 900, the certification information storage apparatus 900 may be constructed to operate only when it is connected to the USB port of the management terminal 800 and is supplied with power from outside.

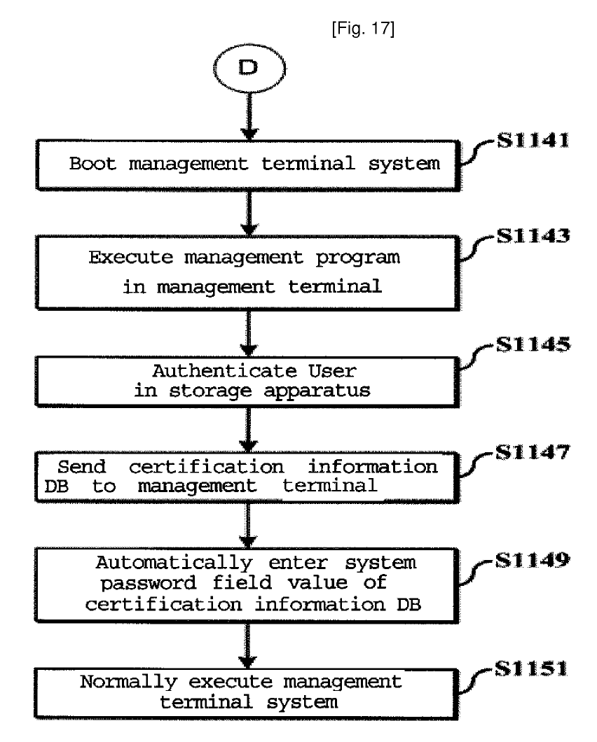

A method of managing certification information DB, such as checking certification information, automatically entering a specific password, etc., through the certification information storage apparatus and the management terminal constructed as described above, will be stepwisely described in detail with reference to FIGS. 13 to 17.

FIG. 13 is a flowchart sequentially illustrating a process of checking certification information, stored in the certification information storage apparatus, through the management terminal.

In the case where the certification information storage apparatus is first used, a password having a predetermined number of digits, which will be used for subsequent user authentication, is received and then registered as a master key at step S1101. Thereafter, the password is substituted into an algorithm for the generation of certification information using a value, in which the master key and a serial number of a certification information storage apparatus are combined, as a seed key, thereby generating certification information at step S1103. The generated certification information includes a predetermined number of passwords. The certification information DB, which has been described with reference to FIGS. 10 to 12, is constructed using the passwords at step S1105. In this case, the certification information DB was generated and stored at the time of shipment from a factory. The generated passwords sequentially fill the password fields 1002, 1012 and 1021 provided in each table of the certification information DB. The entries of the other fields of each table are edited through the certification information management program of the management terminal later. The steps S1101 to S1105 are collectively referred to as the initialization step of the certification information storage apparatus.

The initialization step of the certification information storage apparatus may be similarly applied to the case where an existing storage device has been lost and, consequently, a new storage device is purchased. However, there is a difference in that the serial number at step S1103 is received by the certification information management program of the management terminal. Through this re-initialization step, the previously used certification information DB can be recovered.

It is assumed that the user attempts to perform a specific task through a management terminal while carrying a certification information storage apparatus, and desires to check a password necessary for the corresponding task through the certification information storage apparatus because the user has not memorized all of the large number of passwords in use. In order to check whether the corresponding user is a person who has a legitimate right to use the corresponding storage device prior to the use of the certification information DB of the certification information storage apparatus, a password is received from the user. In the case where the user inputs “ifkey7” as a password, the user inputs “ifkey7” by inputting “South3-East (long)-wait for 2 seconds-West3-East (long)-wait for 2 seconds-East1-West (long)-East1-East (long)-West2-East (long)-wait for 2 seconds-East2-West (long)-West2-West (long)-East (long)-wait for 2 seconds-South1-East (long)”, and then sends a received letter string to the device control unit by pressing the “South” button for a long time, thereby allowing the letter string to be compared with the previously stored master key in the device control unit at S107.

If a device display unit such as an LCD is provided in the certification information storage apparatus in the case where the user is determined to be a legitimate user because the received password is identical to the master key, a sentence, such as “user authentication completed!!”, is displayed on a corresponding device display unit. Subsequently, a sentence such as “please connect storage device to management terminal” may be output. Accordingly, when a corresponding certification information storage apparatus is connected to a specific management terminal through a communication interface such as a USB port, a guide message such as “please press South (S) key long” is displayed on the device display unit of the certification information storage apparatus. Thereafter, when the South (S) key is pressed for a long time, the certification information DB stored in the certification information storage apparatus is sent to the management terminal at step S1111.

In this case, before the certification information DB is sent to the management terminal, the certification information management program for receiving and outputting the certification information DB must first be executed in the management terminal at step S1109. The certification information management program may be directly executed by a user in a state in which it is installed in the management terminal, or may be automatically executed remotely through an automatic execution program provided in the certification information storage apparatus. In the latter case, when the certification information storage apparatus and the management terminal are connected to each other, an automatic execution program provided in a corresponding certification information storage apparatus is executed, and checks whether and the certification information management program has been installed on the management terminal. If the corresponding program has not been installed, the certification information management program is automatically downloaded, installed and then automatically executed. However, if the corresponding program has been installed, the certification information management program is immediately executed.

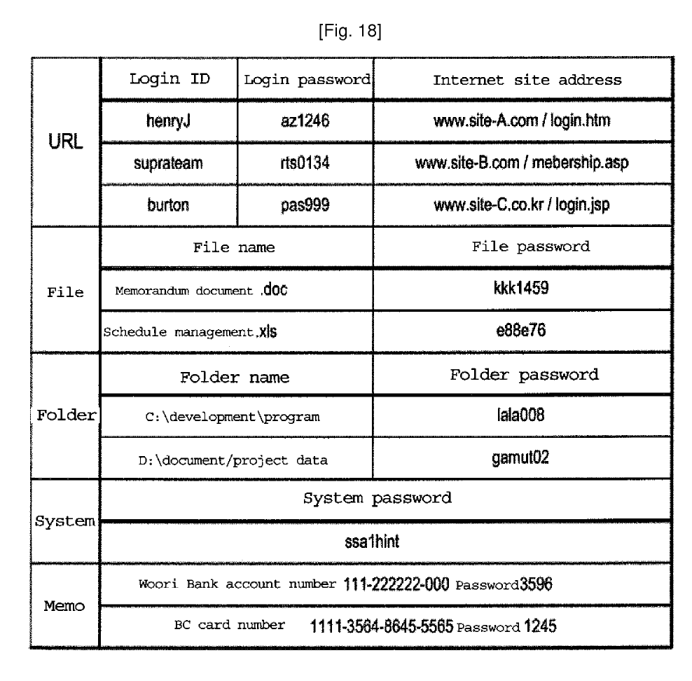

Thereafter, the certification information management program outputs the content of the received certification information DB onto the screen of the management terminal in tabular form at step S1113. An example of the screen onto which the certification information DB is output is shown in FIG. 18. That is, the integrated table of respective tables (first table to fourth table) constituting the certification information DB is displayed on the screen in the form of a single table. In this case, each field value of the certification information DB, which is first output on the screen of the management terminal, may be output as special characters, such as “*******” so that other persons cannot distinguish them. Thereafter, the field value may be converted into general characters, such as “afed1234”, after one more user authentication step, and may then be output according to the user's selection.

The certification information management program of the present invention is not limited to the output of the certification information DB, but further includes a function of automatically providing a specific password, included in the certification information DB, to a specific Internet site or application program. The case where an Internet site is accessed will be described as a detailed example with reference to FIG. 14.

In a state in which the certification information management program is being executed, the user executes a browser included in the management terminal and accesses a desired Internet site at step S1115. In the case where a login ID and password are required for user login to the corresponding site, the user may input the ID and the password using one of the following three methods.

First, when a previously registered browser accesses the site, the certification information management program searches the Internet site address fields of the first table of the certification information DB for address information corresponding to a specific site at step S1117. If there exists a record of the address information, the certification information management program extracts a login ID field value and a login password field value from the corresponding record and automatically entering them in the ID and password input boxes of the corresponding site at step S1119.

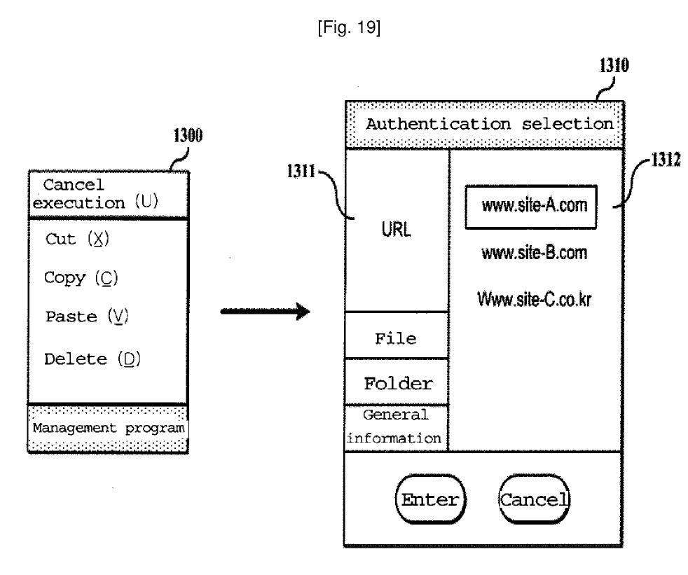

Second, with respect to a method shown in FIG. 19, if the user accesses a specific site and clicks on the right side of the mouse, an assistant menu 1300 pops up. If the user selects a management program menu option from the assistant menu 1300, a simplified management interface window 1310, including lists of Internet sites, files. etc. containing the specific site to which certification information will be input, pops up. For reference, if the user selects “URL” from the left selection bar 1311 of the simplified management interface window 1310, values registered in the Internet site address fields of the first table of the certification information DB are listed on a right list bar 1312; if the user selects “general information” from the left selection bar 1311, values registered in the memo fields of the fourth table are listed on the right list bar 1312. If the user selects “URL” from the left selection bar 1311 and selects a site address corresponding to the site being accessed from the right list bar 1312, the certification information management program automatically enters the login ID field value and login password field value of a record corresponding to the corresponding site address in the ID and password input boxes of the corresponding site.

Third, there is a method in which the user directly selects and copies a desired login ID field value and a login password field value from the certification information DB output screen of FIG. 18 and pastes them in the input boxes of a corresponding site.

If site address information corresponding to the certification information DB does not exist, a user must directly input an ID and password at step S121. If correct ID and password are input using this input method or any one of the above-described methods, the user can log in to a corresponding site at step S1123.

Next, the case where a specific file is executed will be described as an example of the automatic password entering function of the certification information management program with reference to FIG. 15.

When the user desires to execute a specific application and fetch a specific file in a state in which the certification information management program has been executed at step S1125, the above-described three methods may be used in the similar way if the corresponding file requires user authentication. That is, in the case where the corresponding application has been registered with the certification information management program at step S1127, a password field value for the corresponding file is automatically entered using the first method at step S1129. In the case where the file has been selected from the left selection bar 1311 of the simplified management interface window 1310, a password field value for a corresponding file is automatically entered using the second method. The third method and the method of direct input by a user (S1131) may be applied in the same way. If the entered password is correct, the corresponding file is opened at step S133.

Next, an embodiment of the certification information editing function of the certification information management program will be described with reference to FIG. 16.

In a state in which the certification information DB is output onto the screen of the management terminal, the user selects a specific field available for editing using a selection means, such as a mouse, and edits the selected field using an input means, such as a keyboard, at step S1135. In the present embodiment, the editable fields are limited to login ID fields, Internet site address fields, file name fields and memo fields. The field values of the respective password fields can be generated and modified only within the certification information storage apparatus. If the entire editing is completed, a modified certification information DB is sent to the certification information storage apparatus by activating a menu provided in the certification information management program at step S137. The certification information storage apparatus, having received the modified certification information DB, replaces an existing certification information DB with the received certification information DB at step S1139.

Last, an embodiment in which the certification information entering function of the certification information management program is applied to the booting process of a management terminal will be described with reference to FIG. 17.

When the management terminal is booted at step S1141 in a state in which the initialization steps S1101 to S1105 of the certification information storage apparatus have been performed, various batch programs are executed by a ROM BIOS. The batch programs also include the certification information management program of the present invention. If a system password has been set in a corresponding management terminal, the certification information management program is executed at step S1143, and thereafter the booting process is then temporarily stopped while the user is asked of the system password. After user authentication has been normally performed in the certification information storage apparatus at step S145, the certification information storage apparatus is connected to the management terminal and the certification information DB is sent to the management terminal at step S1147. The certification information management program, having received the certification information DB, automatically fetches a system password field value for a corresponding management terminal and enters it in the system password input box at step S449, thus allowing booting to normally continue at step S1151.

As described above, although the specific embodiments have has been described in the present specification of the present invention, various modifications without departing from the scope of the invention. Therefore, the scope of the present invention is not limited to the described embodiments, and should be defined by not only the following claims but also the equivalents thereof.

1. A password management method of accessing and managing desired passwords through a portable password management apparatus (hereinafter referred to as a ‘management apparatus’ and a terminal (hereinafter referred to as a ‘management terminal’) on which a password management program is installed, the password management method comprising:
a first step of executing the password management program on the management terminal;
a second step of receiving a user authentication number (hereinafter referred to as a ‘first authentication number’) from the management apparatus, and
comparing the first authentication number with a user authentication number (hereinafter referred to as a ‘second authentication number’) previously stored in the management terminal, thereby authenticating whether a user is a legitimate user; and
a third step of, only if the user is authenticated as a legitimate user, receiving a password list from the management apparatus and outputting the received password list onto a screen.

2. The password management method of claim 1, further comprising the steps of:
if the second authentication number is not previously stored in the management terminal,
requesting self-authentication from the management apparatus, and
performing the third step only when notification of successful self-authentication is provided by the management apparatus.

3. The password management method of claim 2, wherein the self-authentication in the management apparatus comprises the steps of:
receiving a password through an input unit of the management apparatus;
comparing the received password and the user authentication number previously stored in the management apparatus; and
notifying the management terminal of successful self-authentication if the received password is identical to the user authentication number, and notifying the management terminal of unsuccessful self-authentication if the received password is not identical to the user authentication number.

4. The password management method of claim 1, further comprising the steps of:
modifying a specific field of a specific record of the password list output to the management terminal; and
sending a modified password list to the management apparatus and backing up the password list.

5. The password management method of claim 1, further comprising the steps of:
adding a new record to the password list; and
sending the password list, to which the new record is added, to the management apparatus and backing up the password list.

6. The password management method of claim 4 or 5, wherein each record of the password list includes a description field for a password, and a password field.

7. The password management method of claim 6, wherein the modification of the specific field or the addition of the new record is performed through input means of the management terminal.

8. The password management method of claim 6, wherein the modification of the specific field or the input of the password field of the new record is performed through an input unit of the management apparatus.

9. The password management method of claim 1, further comprising a reference information setting step, the reference information setting step comprising the steps of:
setting a communication interface type and a transmission speed that are used to perform communication between the management terminal and the management apparatus;
requesting the user authentication number from the management apparatus based on the set communication interface type and transmission speed; and
storing the set communication interface type and transmission speed and the user authentication number, received in response to the request, in the management terminal.

10. The password management method of claim 9, further comprising, before the step of requesting the user authentication number, the steps of:
requesting a serial number of a corresponding device from the management apparatus; and
proceeding to a subsequent step only if the serial number received from the management apparatus is identical to a serial number previously stored in the management terminal.

11. The password management method of claim 1, further comprising a certification information mediation step, the certification information mediation step comprising the steps of:
receiving a user authentication number (hereinafter referred to as a ‘third authentication number’) received through an input unit of the management apparatus, and
providing the received third authentication number to a specific application requiring user authentication.

12. The password management method of any one of claims 1 to 5 and 9 to 11, wherein the communication between the management terminal and the management apparatus is performed via encryption using a predetermined algorithm.

13. The password management method of claim 12, wherein the communication between the management terminal and the management apparatus is performed wirelessly through a relay apparatus connected to the management terminal via a wired communication interface.

14. The password management method of claim 12, wherein the communication between the management terminal and the management apparatus is performed in a wired manner through direct connection between a communication interface of the management terminal and a communication interface of the management apparatus.

15. The password management method of claim 1, wherein the user authentication number is generated by selecting two or more keys provided in an input unit of the management apparatus according to a specific pattern.

16. A portable password management apparatus (hereinafter referred to as a ‘management apparatus’) for accessing a desired specific password through a terminal (hereinafter referred to as a ‘management terminal’) on which a password management program is installed, the management apparatus comprising:
a memory unit for storing a user authentication number for accessing the program and a password list to be managed;
an input unit for receiving the user authentication number and passwords;
a communication interface for exchanging various data with the management terminal; and
a control unit for, if there is a request for a user authentication number from the management terminal, receiving a password through the input unit and sending the received password to the management terminal, and sending a previously stored password list to the management terminal when the management terminal requests the password list.

17. The portable password management apparatus of claim 16, wherein the control unit further comprising a function of, if there is a request for self-authentication from the management terminal, receiving the password through the input unit, comparing the received password with a previously stored user authentication number, and notifying the management terminal of successful self-authentication or unsuccessful self-authentication based on a comparison result.

18. The portable password management apparatus of claim 16, wherein the control unit further comprises a function of backing up the password list in the memory unit if a password list, in which a specific record is modified or added, is received from the management terminal.

19. The portable password management apparatus of claim 16, wherein the control unit further comprises a function of sending a serial number, previously stored in the memory unit, to the management terminal if there is a request for the serial number of the management apparatus so as to set reference information from the management terminal.

20. The portable password management apparatus of claim 16, further comprising a display unit for outputting an ID field value or password field value of a specific record of the password list stored in the memory unit.

21. The portable password management apparatus of any one of claims 16 to 20, wherein each record of the password list comprises a description field for a password and a password field.

22. The portable password management apparatus of claim 21, wherein the user authentication number is generated by selecting two or more keys, provided in an input unit of the management apparatus, according to a specific pattern.

23. The portable password management apparatus of claim 21, wherein the communication between the management terminal and the management apparatus is performing via encryption using a predetermined algorithm.

24. A certification information management method of accessing, managing and applying various types of certification information using a certification information storage apparatus and a management terminal, the certification information management method comprising:
a user authentication step of determining whether a user is a legitimate user in a certification information storage apparatus by comparing a password, received from a user, and a previously stored password (master key);
a certification information sending step of sending a certification information DB, previously stored in the certification information storage apparatus, to the management terminal via a communication interface; and
a certification information output step of outputting the received certification information DB onto a screen through a certification information management program of the management terminal.

25. The certification information management method of claim 24, wherein the certification information DB comprises a first table, including login ID fields, password fields for corresponding IDs, and address fields for Internet sites to which corresponding login IDs and passwords will be applied.

26. The certification information management method of claim 25, further comprising a certification information application step, the certification information application step comprising the steps of:
the management terminal accessing a specific Internet site through a browser;
the certification information management program searching the first table for an address identical to that of the accessed Internet site; and
automatically entering a login ID field value and a password field value for the identical address in login ID and password input boxes of the corresponding site.

27. The certification information management method of claim 24 or 25, wherein the certification information DB further comprises a second table, including file name fields, and password fields for corresponding files.

28. The certification information management method of claim 27, further comprising a certification information application step, the certification information application step comprising the steps of:
the management terminal requesting a password from a user as a specific file is selected or executed;
the certification information management program searching the second table for a file name identical to that of the selected specific file; and
automatically entering a password field value for the identical file name in a password input box of the specific file.

29. The certification information management method of claim 24 or 25, wherein the certification information DB further comprises a third table, including a system password field for the management terminal.

30. The certification information management method of claim 29, further comprising the steps of:
requesting a system password from a user as the management terminal is booted;
the certification information management program automatically substitute a system password field value of the certification information DB for the system password.

31. The certification information management method of claim 24 or 25, wherein the certification information DB further comprises a fourth table, including memo fields having a predetermined size.

32. The certification information management method of claim 31, further comprising a certification information editing step, the certification information editing step comprising the steps of:
editing one or more of a login ID field, an Internet site address field, a file name field and a memo field of the certification information DB through the certification information management program; and
sending a certification information DB, modified through the editing, to the certification information storage apparatus and updating a certification information DB of a corresponding certification information storage apparatus.

33. The certification information management method of claim 24, further comprising a certification information storage apparatus initialization step, the certification information storage apparatus initialization step comprising:
a master key registration step of the certification information storage apparatus receiving a password having a predetermined number of digits for user authentication, and storing the received password as a master key;
a seed key input step of substituting the password into an algorithm for generating certification information using the master key as a seed key; and
a certification information DB construction step of constructing a database using a predetermined number of pieces of certification information generated by the algorithm.

34. The certification information management method of claim 33, wherein the seed key is a combination of the master key and a serial number of a corresponding certification information storage apparatus.

35. The certification information management method of claim 34, wherein the seed key input step is performed using a serial number received through the certification information management program of the management terminal, instead of a serial number that is previously stored in the certification information storage apparatus.

36. A certification information storage apparatus, comprising:
a device input unit for receiving a password for user authentication and commanding a certification information DB to be sent to a management terminal;
a device storage unit for storing various data, including a certification information DB composed of various types of authentication-related information, a master key, that is, a password previously stored for user authentication, and a serial number used for generating certification information;
a device communication interface for performing data communication with the management terminal to send the certification information DB; and
a device control unit for determining whether a user is a legitimate user by comparing a password received from the user through the device input unit and a master key previously stored in the device storage unit, and sending the certification information DB to the management terminal through the device communication interface according to the user’ selection if the user is determined to be a legitimate user.

37. The certification information storage apparatus of claim 36, wherein the device input unit comprises two or more key buttons, and the key buttons perform specific functions assigned thereto when the buttons are pressed for a time longer than a predetermined time, and receive characters assigned thereto when the buttons are pressed for a time less than the predetermined time.

38. The certification information storage apparatus of claim 37, wherein:
the key buttons are four in number;
each of the buttons inputs a predetermined number according to a number of times that the button is pressed if the button is pressed for a time shorter than a predetermined time; and
the buttons respectively perform functions of: 1) conversion of a currently input value into a number/character, 2) temporary storage of a currently input value and waiting for input of a new value, 3) cancellation of a currently input value, and 4) sending of the certification information DB to the management terminal if the buttons are pressed for a time longer than the predetermined time.

39. The certification information storage apparatus of any one of claims 36 to 38, further comprising a display unit for outputting one or more of a key value received through the device input unit, details of a selected function, and operational status of the certification information storage apparatus.

40. The certification information storage apparatus of claim 36, wherein the device communication interface is implemented to selectively perform wired communication via a Universal Serial Bus (USB) and wireless communication via Infrared Data Association (IrDA).

41. The certification information storage apparatus of claim 36, wherein the certification information DB comprises a first table, comprising login ID fields, password fields for corresponding IDs, and address fields for Internet sites to which corresponding login IDs and passwords will be applied.

42. The certification information storage apparatus of claim 41, wherein the certification information DB further comprises a second table, including file name fields, and password fields for corresponding files.

43. The certification information storage apparatus of claim 36 or 37, wherein the certification information DB further comprises a third table, including a system password field for the management terminal.

44. The certification information storage apparatus of claim 43, wherein the certification information DB further comprises a fourth table, including memo fields having a predetermined size.

45. The certification information storage apparatus of claim 44, wherein the device control unit further comprises a function of updating the certification information DB of the storage device based on the modified certification information DB if a certification information DB in which one or more of a login ID field, an Internet site address field, a file name field and a memo field are edited is received from the management terminal.

46. The certification information storage apparatus of claim 36, wherein the device control unit further comprises a function of receiving a password having a predetermined number of digits for user authentication through the device input unit, storing the received password in the device storage unit as a master key, substituting the password into an algorithm for generating certification information using the master key as a seed key, and constructing the certification information DB using a predetermined number of pieces of certification information generated by the algorithm.

47. The certification information storage apparatus of claim 46, wherein the seed key is a value obtained by combining the master key with a serial number of a corresponding certification information storage apparatus.

48. The certification information storage apparatus of claim 47, wherein the device control unit further comprises a function of generating certification information using a serial number, received through the certification information management program of the management terminal, instead of a serial number that is previously stored in the certification information storage apparatus.

49. The certification information storage apparatus of claim 36, further comprising a power supply unit for supplying power to the respective elements.
